(19) United States
(12) Patent Application Publication
(10) Pub. No.: US 2008/0005232 A1
(43) Pub. Date: Jan. 3, 2008

(54) ENHANCED GROUP ADVERTISEMENT TO ALLOW REJECTION AND RECEIVE GROUP MEMBER DETAILS

(76) Inventor: Hui FENG, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/427,016

(22) Filed: Jun. 28, 2006

(51) Int. Cl. G06F 15/16

(52) U.S. Cl. 709/204

(57) ABSTRACT

Disclosed is a system, method and computer application for unambiguously identifying electronic equipment and/or users prior to requiring an invited user in a push-to-talk (PTT) and/or push-to-talk over cellular (PoC) type communications to join a group session in which the user was invited. An invitation is transmitted to a plurality of members by a first associated electronic equipment to join a PTT and/or PoC group session. The invitation generally includes member information relating to the members receiving the invitation. The member information is presented to the invited users. The electronic equipment of the invited users receive user input to accept and/or reject the invitation to join the group session based at least in part on the portion of the member information presented to the associated user. A session group is formed based on the electronic equipment accepting the invitation.

### TECHNICAL FIELD OF THE INVENTION

The present invention relates to a method and system for communications between electronic equipment utilizing push-to-talk (PTT) and/or push-to talk over cellular (PoC) type communication protocols.

### DESCRIPTION OF THE RELATED ART

Push-to-talk (PTT) and Push-to-talk over cellular (PoC) type communications between electronic equipment are becoming increasingly popular with wireless communication customers. In general, PTT and PoC type systems are designed to provide an instant messenger service, similar to a walkie-talkie service. PTT and PoC type communications support instant group sessions. An instant group session enables a user of an inviting electronic equipment to establish a group session with a predefined group of electronic equipment. For example, a user may populate one or more user groups in advance by selecting and storing a list of electronic equipment for each user group in the memory of a PTT or PoC server in a wireless network. Each predefined user group generally has an associated group ID. To establish the instant group session, the inviting electronic equipment selects one of the predefined user groups and requests that the PTT or PoC server establish the group session with the selected user group. In response, the PTT or PoC server retrieves the selected user group from memory using the associated group ID, evaluates any access requirements, and sends an invite message to each mobile terminal identified by the selected user group that satisfies any access requirements. The PTT or PoC server then establishes the group session between the inviting electronic equipment and any invited electronic equipment that accept the invitation.

The instant group session also enables a user of an inviting electronic equipment to establish a group chat with an ad hoc group of manually selected electronic equipment. The inviting electronic equipment provides the ad hoc group to the PTT or PoC server and requests that the server establish a group session with the selected electronic equipment. In response, the server sends an invite message to each electronic equipment identified in the ad hoc request that satisfies any access requirements. The PTT or PoC server then establishes the group session between the inviting electronic equipment and any invited electronic equipment that accept the invitation.

One drawback with conventional PTT and PoC type communications is that invited members of the group are generally unaware of the other members of the group. An additional drawback with conventional PTT and PoC type communications is that the invited member does not have the option to accept and/or reject membership to the group.

### SUMMARY

In view of the aforementioned shortcomings associated with identifying and connecting to electronic equipment in a PTT and/or PoC type communication system, there is a strong need in the art for a method and system to unambiguously identify electronic equipment and/or users prior to requiring an invited user to join the group.

One aspect of the present invention is directed to a method for establishing a group session, the method including: receiving an invitation from an inviting associated electronic equipment to join a group session, wherein the invitation includes member information relating to a plurality of members receiving the invitation; presenting at least a portion of the member information to an associated user of an invited electronic equipment; receiving user input from the associated user of the electronic equipment to accept or reject the invitation to join the group session based at least in part on the portion of the member information presented to the associated user.

According to an aspect of the invention, the group session is a push to talk group session.

According to an aspect of the invention, the group session is a push to talk over cellular group session.

According to an aspect of the invention, the member information is embedded in the invitation.

According to an aspect of the invention, the member information is in the form of XML code.

According to an aspect of the invention, the member information includes a user friendly designation of at least one of the plurality of members.

According to an aspect of the invention, the member information includes a user friendly designation of at least one of the plurality of members.

According to an aspect of the invention, the member information includes a session initiation protocol uniform resource identifier associated with at least one of the plurality of members.

According to an aspect of the invention, a step of transmitting a rejection of the invitation to the associated first electronic equipment;

According to an aspect of the invention, a step of rejecting information in the rejection, wherein the rejecting information includes a reason for rejecting the invitation to join the group session.

Another aspect of the present invention is directed to a method for establishing a group session, the method including: transmitting an invitation to a plurality of associated electronic equipment to join a group session from an inviting electronic equipment, wherein the invitation includes member information associated with users of the plurality of associated electronic equipment; receiving a response from at least a portion of the associated electronic equipment, wherein the response includes either an acceptance or rejection of the invitation; and forming a group session based on the electronic equipment that accepted the invitation.

According to an aspect of the invention, the group session is a push to talk group session.

According to an aspect of the invention, the group session is a push to talk over cellular group session.

According to an aspect of the invention, the member information is in the form of XML code.

According to an aspect of the invention, the member information includes a user friendly designation of at least one user of the plurality of electronic equipment.

According to an aspect of the invention, the member information includes a user friendly designation associated with each user of the plurality of electronic equipment.

According to an aspect of the invention, the invitation includes a session initiation protocol uniform resource identifier associated with each of the plurality of members.

According to an aspect of the invention, at least one response includes a rejection of the invitation to join the group session.

According to an aspect of the invention including rejection information, wherein the rejection information includes a reason for rejecting the invitation to join the group session.

Another aspect of the present invention is directed to a computer program stored on a machine readable medium, the program being suitable for use in an electronic equipment having an push to talk over cellular application, wherein when the electronic equipment transmits an invitation to a group of electronic equipment, wherein the invitation includes member information associated with invitation, at least one member of the group may view the member information and reject the invitation based at least in part on the portion of the member information viewed by the at least member of the group.

According to an aspect of the invention, the member information is embedded in the invitation.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

It should be emphasized that the term “comprise/comprising” when used in this specification is taken to specify the presence of stated features, integers, steps or components but does not preclude the presence or addition of one or more other features, integers, steps, components or groups thereof.”

The term “electronic equipment” includes portable radio communication equipment. The term “portable radio communication equipment”, which herein after is referred to as a mobile radio terminal, includes all equipment such as mobile telephones, pagers, communicators, i.e., electronic organizers, personal digital assistants (PDA's), portable communication apparatus, smart phones or the like.

### BRIEF DESCRIPTION OF THE DRAWINGS

The foregoing and other embodiments of the invention are hereinafter discussed with reference to the drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an exemplary illustration of a communication system in accordance with aspects of the present invention.

FIG. 2 is a schematic diagram illustrating electronic equipment in accordance with aspects of the present invention.

FIG. 3 is an exemplary illustration of a communication system in accordance with aspects of the present invention.

FIGS. 4 and 5 are exemplary signaling methods in accordance with aspects of the present invention.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

Aspects of the invention include electronic equipment and a method and system of identifying electronic equipment and/or associated users prior to requiring an invited user in a PTT and/or PoC type communications to join a group in which the user was invited. In one aspect, an invitation is transmitted to a plurality of members by the first associated electronic equipment to join a PTT and/or PoC group session. The invitation includes member information relating to the members receiving the invitation. The member information is presented to the invited users. The electronic equipment of the invited users receive user input to accept and/or reject the invitation to join the group session based at least in part on the portion of the member information presented to the associated user.

In another embodiment, an invitation to join a group session is transmitted to a plurality of associated electronic equipment by an inviting electronic equipment. The invitation includes member information associated with users of the plurality of associated electronic equipment. In response to the invitation, a response from at least a portion of the associated electronic equipment is received, wherein the response includes either an acceptance or rejection of the invitation. Based upon the response (e.g., if the user accepts the response), a group session is formed which includes one or more of the invited electronic equipment that accepted the invitation.

As used herein, the term “electronic equipment” includes portable radio communication equipment. The term “portable radio communication equipment”, which herein after may be referred to as a mobile phone, a mobile device, a portable communication device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of electronic equipment capable of being used in connection with PTT and/or PoC type communications.

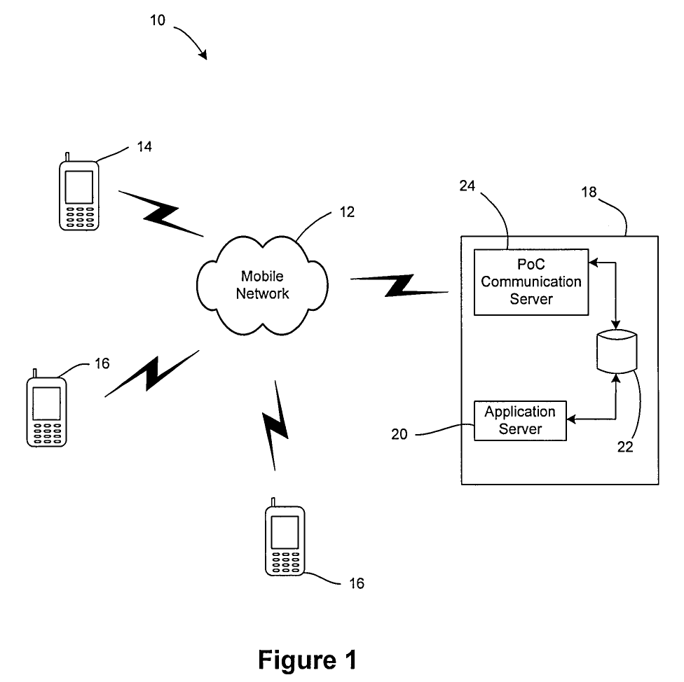

Referring initially to FIG. 1, a communication system 10 includes a mobile network 12, such as a mobile cellular telephony network, that facilitates communication, such as voice communication and/or data transfer between a plurality of portable communication devices 14 and 16, such as mobile phones, electronic equipment or the like. The communication system 10 and at least two of the portable communication devices 14, 16 support PTT and/or PoC communications, e.g., by including a PTT and/or PoC application program. For purposes of the discussion contained herein, portable communication device 14 will be described in terms of inviting, initiating and/or activating a PoC group session with portable communication devices 16. However, it will be appreciated that the method described more fully below can be carried out by any suitably equipped portable communication device, regardless of whether that device initiates a PoC session or responds to an invitation to participate in a PTT session. In addition, while the invention is described with respect to PoC, the invention is also directed to all other push-to-talk communication protocols (e.g., PTT and the like).

The communication system 10 includes a network infrastructure 18, portions of which are used or otherwise accessed by the portable communication devices in connection with aspects of the invention. The portable communication devices 14, 16 may interact with each other and/or the network infrastructure in accordance with any suitable communication standard, including, but not limited to, Advanced Mobile Phone Service (AMPS), Digital Advanced Mobile Phone Service (D-AMPS), General Packet Radio Service (GPRS), Universal Mobile Telecommunications System (UMTS), Global System for Mobile Communications (GSM), Code Division Multiple Access (CDMA), Voice-Over IP (VoIP), Session Initiated Protocol (SIP), Wireless Local Area Network (WLAN) or the like. In other words, the communication system is shown in FIG. 1 for purposes of explaining aspects of the present invention, without limiting the invention to a particular communication system design, architecture or communication standard.

The network infrastructure 18 includes one or more application servers, which are indicated generally by the numeral 20, and a storage device 22, such as a memory for storing data accessible or otherwise usable by the application servers 18. At least one of the application servers is a push-to-talk over cellular (PoC) communication server 24. The application servers 18, including the PoC communication server 24, are computer servers that serve different functions in the communication system. As is described more fully below, the portable communication devices 14 and 16 are operable to view potential group members to which an invitation has been sent and/or to accept or reject a group invitation to a PoC group session prior to joining the group session.

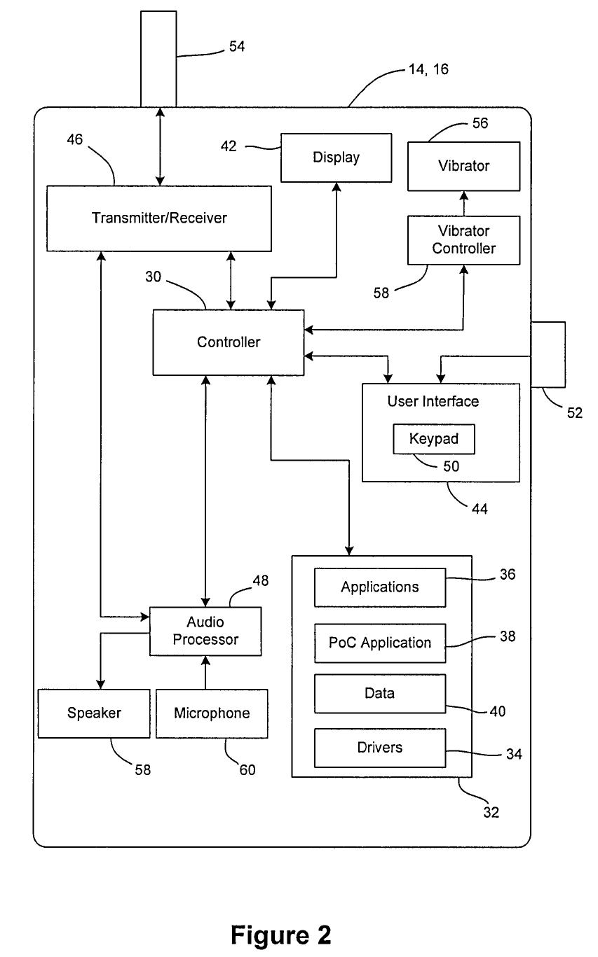

FIG. 2 represents a functional block diagram of a portable communication device 14, 16 in accordance with aspects of the present invention. The portable communication device 14, 16 includes a controller 30 for controlling the overall operation of the portable communication device. The controller 30 may be any commercially available or custom microprocessor. Memory 32 is operatively connected to the controller 30 for storing control programs and data used by the portable communication device. The memory 32 is representative of the overall hierarchy of memory devices containing software and data used to implement the functionality of the portable communication device in accordance with aspects of the present invention.

In the illustrated embodiment, memory 32 stores device drivers 34, e.g., I/O device drivers, application programs, indicated generally by reference numeral 36 generally, including a PoC application program 38 (also referred to as a PoC processor) and application program data 40 that supports the functionality described more fully herein. The I/O device drivers include software routines that are accessed through the controller 30 (or by an operating system (not shown) stored in memory 32) by the application programs 36, including the PoC application program 38, to communicate with devices such as the display 42 and other input/output ports.

The application programs 36, including the PoC application program 38, comprise programs that implement various features of the portable communication device 14,16, such as e-mail, Internet access, contact manager and the like. As is discussed more fully below, the PoC application program 38 comprises a program that facilitates PoC communications, including presenting and/or viewing potential group members and accepting or rejecting an invitation to join a PoC group session prior to actually joining the group session based at least in part on the potential group members presented and/or viewed.

A person having ordinary skill in the art of computer programming, and specifically in applications programming for portable communication devices (e.g., mobile phones), will consider it obvious in view of the description provided herein to program a mobile phone to operate and carry out the functions described herein with respect to the PoC application program 38 (and any interfacing between the PoC application program 38 and other application programs 36 present on the mobile phone). Accordingly, details as to specific programming code have been left out for the sake of brevity. Also, while the PoC communication functionality, including viewing potential group members and/or accepting or rejecting an invitation to join a PTT group session prior to actually the group session, is carried out via the processor and PoC application program 38 (alone or in conjunction with other application programs and control modules) in memory 32 in accordance with aspects of the invention, such function could also be carried out via dedicated hardware, firmware, software or combinations thereof without departing from the scope of the present invention.

With continued reference to FIG. 2, the controller 30 interfaces with the display 42, a user interface unit 44, a transmitter/receiver 46 (often referred to as a transceiver) and audio processing circuits, such as an audio processor 48, e.g., an audio processing circuit. In the illustrated embodiment, the user interface unit 44 includes or is operatively coupled to a keypad 50 and a PoC actuator 52, e.g., a button used to initiate PoC functions, such as initiating a PoC communication session, taking control of the floor and the like, during a typical PoC communication session. While the PoC actuator 52 is depicted as a separate and dedicated user interface button, it will be appreciated that other existing buttons or keys on the mobile phone, e.g., one or more of the keys within the keypad 50 (so-called “soft keys), may be employed to provide the PoC functionality. In other words, the present invention is not intended to be limited to any particular configuration or geometry of PoC actuators.

The display 42, keypad 50 and the PoC actuator 52 are part of a user interface unit 44 that allows the user to interact with the mobile phone 14, 16. For example, keypad 50 allows the user to dial numbers, enter commands and data, and select options. The display 42 allows the user to view a variety of information, such as dialed digits, stored information, and output from various applications, including the PoC application program 38. As is discussed more fully below, the PoC actuator 52 allows a user to initiate a PoC session, e.g., inviting one or more other users to participate in a PoC communications session, and/or take control of the floor for speaking during the PoC communications session, in response to or otherwise based on silent call pacing signals provided by the mobile phone.

An antenna 54 is coupled to the transmitter/receiver 46 such that the transmitter/receiver 46 transmits and receives signals via the antenna 54, as is conventional. The portable communication device 14, 16 includes an audio processor 48 for processing the audio signal transmitted by and received from the transmitter/receiver 46. Coupled to the audio processor 48 are a speaker 58 and microphone 60, which enable a user to listen and speak via the portable communication device.

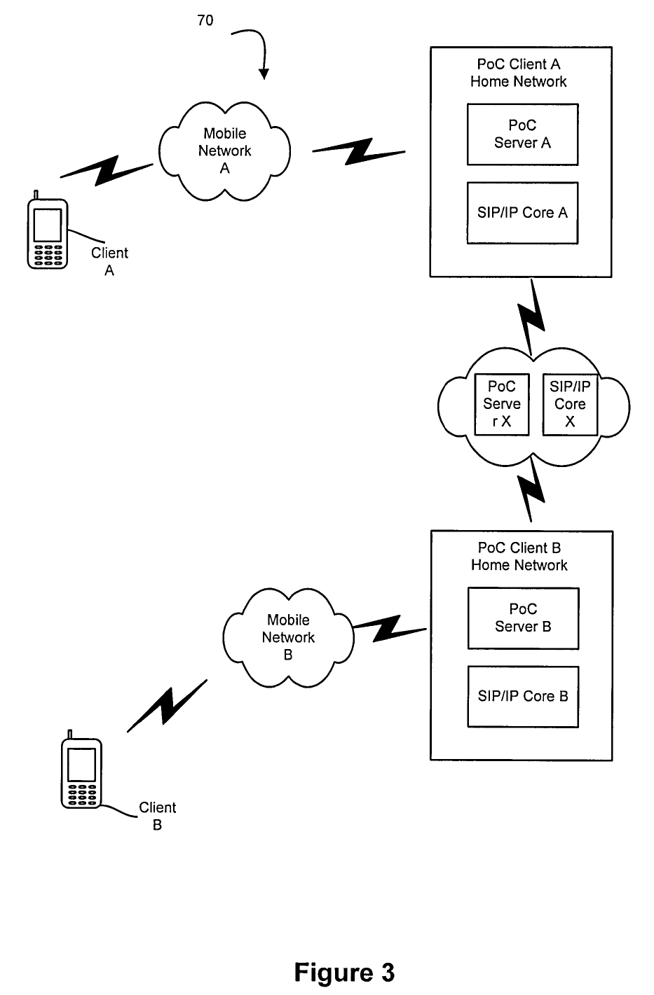

While for purposes of simplicity of explanation, the signaling charts illustrated in FIGS. 3-5, include a series of steps or functional blocks that represent one or more aspects of the relevant operation of the portable communication device 14, 16, it is to be understood and appreciated that aspects of the present invention are not limited to the order of steps or functional blocks, as some steps or functional blocks may, in accordance with aspects of the present invention, occur in different orders and/or concurrently with other steps or functional blocks from that shown and described herein. Moreover, not all illustrated steps or functional blocks of aspects of relevant operation may be required to implement a methodology in accordance with an aspect of the invention. Furthermore, additional steps or functional blocks of aspects of relevant operation may be added without departing from the scope of the present invention.

One of ordinary skill in the art will appreciate that, in general, the signal flow associated with a PoC communication session includes one user attempting to activate or otherwise initiate a PoC communication session by transmitting an activation request, e.g., by pressing the appropriate actuator or PoC call button. An appropriate server, e.g., a PoC communication server verifies that a PoC communication channel is available, and then assigns a channel to the requesting mobile phone. Any message provided by the user of the requesting mobile phone is received by the PoC communication server and relayed to each receiving or invited mobile phone. Once a PoC communication session is established between at least two mobile phones, only one party at a time may speak or otherwise transmit data. Typically, this is accomplished by the user pressing and holding the PoC actuator on the mobile phone (also referred to as taking control of the floor). Typically, floor control is granted or otherwise established by the controlling PoC communication server. A user may continue to speak while the user has control of the floor. When the user is finished speaking, the user may release the PoC actuator, thereby relinquishing control of the floor so that another participant in the PoC communication session may speak after taking control of the floor.

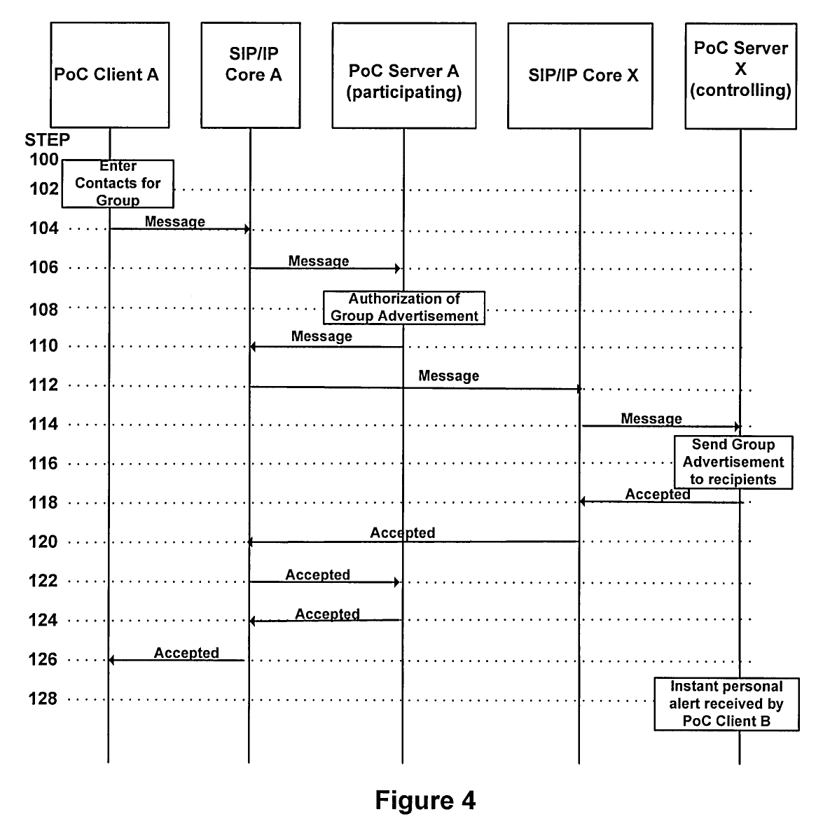

Aspects of the invention related to establishing a group session will now be discussed. Exemplary methods 100 and 150 in accordance with aspects of the present invention are shown in FIGS. 3-5. Referring to FIGS. 3 and 4, at step 102, a user of client A (e.g., electronic equipment 14) desiring to establish a group session, enters a plurality of contacts in which the user desires to form a group. The contacts may be entered from an electronic phonebook or entered manually. The contacts generally comprise the identity of the potential members to the session group. Typically, a group may contain one or more common characteristics and/or traits depending on the group name. For example, the group entitled “Running Buddies” may relate to persons with whom the user runs and/or otherwise exercises with. The group entitled “College Buddies” may relate to persons with whom the user was friends with during college.

Once the group of members is established by the user of client A (e.g., inviting electronic equipment 14), at step 104 the PoC client A sends a SIP message request to SIP/IP Core A. The Request-URI generally includes the PoC Group address (e.g., SIP:OMA-RunningBuddies@networkX.net), SIP Headers (e.g., P-Preferred-Identity, Accept-Contact, User-Agent, Content-Type, etc.) and a message body. The XML MIME body of group advertisement generally includes the following exemplary code:

```
<group-advertisement
    xmlns=“urn:oma:params:xml:ns:poc:group.advertisement”
    xmlns:xsi=http://www.w3.org/2001/XMLSchema-instance
    xsi:schemaLocation=“urn:oma:param s:sml:ns:poc:group-
    advertisement”>
    <note> I set this group up for us runners</note>
    <group type=“dialed-in”>
        <display-name>RunningBuddies</display-name>
        <uri>sip:OMA-Running-Buddies@networkX.net</uri>
    </group>
</group-advertisement>
```

In order to identify the members of the group additional member code may be included in the body of the group advertisement. Exemplary member code may include, for example:

| </member number> 3 </member number> | |
|---|---|
| </members> | client -A: (SIP URI of client 14) |
| | client-B: (SIP URI of client 16) |
| | client-C: (SIP URI of client 16) |
| </members> | |

Such exemplary member code may be included, attached and/or embedded in any part (e.g. body, header, etc.) of the group advertisement. The member code may be any suitable format. As shown the member code is extensible markup language (XML) code. When such code is rendered and/or executed by a suitable view and/or application program, the member information will be present and/or display the contacts (e.g., members of the group) that were invited to partake in the group by the client A (e.g., inviting electronic equipment 14). The member code generally includes a name and/or other identifier associated with the client that will enable a user to determine the identity of the member. The member code may also provide the SIP address of the uniform resource identifier associated with each member. When the group advertisement is received by the group members, the member names will generally be displayed on the on the display of each user's mobile terminal. This will allow the individual members to know the identity of all the other users in a group prior to accepting or rejecting the invitation to the PoC session. In another embodiment, the names of the group members may also be audible by a speech synthesizer and output out a speaker included in the user's mobile terminal.

At step 106, the SIP/IP core A forwards the SIP message request to the PoC server A based on the on the feature-tag in the Accept-Contact header (e.g., “+g.poc.groupad”). At step 108, the PoC server A authorizes the PoC User 14 at the PoC Client A to send a group advertisement. At step 110, The PoC Server A forwards the SIP message request to SIP/IP Core A. At Step 112, the SIP/IP core A forwards the SIP message to the SIP/IP Core X. At Step 114, the SIP/IP Core X forwards the SIP message request to the PoC server X.

At step 116, the PoC Server X initiates the sending of the group advertisement to the recipients, include PoC Client 16. At step 118, a SIP 202 “Accepted” response is sent by PoC Server X to SIP/IP Core X. At step 120, SIP/IP Core X forwards the SIP 202 “Accepted” response to SIP/IP Core A. At step 122, SIP/IP Core A forwards the SIP 202 “Accepted” response to PoC Server A. At step 124, the PoC Server A forwards the SIP 202 “Accepted” response to SIP/IP Core A. At step 126, the SIP/IP Core A forwards the SIP 202 “Accepted” response to PoC Client A. At step 128, The PoC Server X receives an acknowledgement from the PoC Client B Network that the PoC Client B has received the group advertisement.

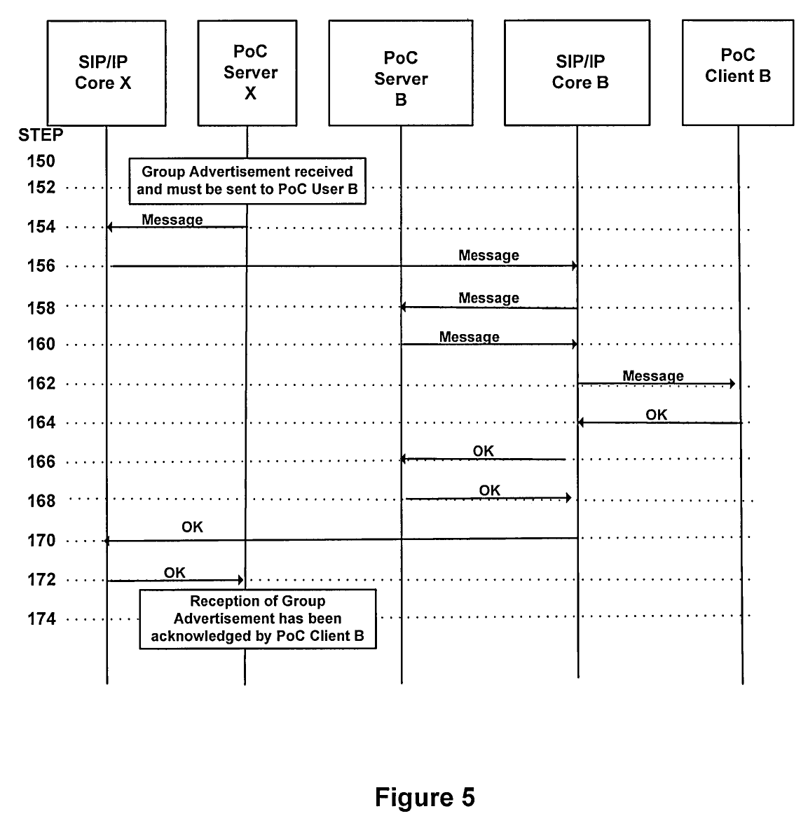

Referring to FIGS. 3 and 5 an exemplary method 150 for message flow between a receiver (e.g. PoC Client B, electronic equipment 16) of the group advertisement is illustrated. At step 152, PoC Server X receives an authorized request from a PoC User A to send a Group Advertisement to a PoC Group that includes PoC User 16. At step 154, the PoC Server X sends a SIP Message request to the SIP/IP Core X. The Request-URI includes the PoC Address of the PoC User B and an Accept-Contact header with the tag“+g.poc.groupad”. At step 156, the SIP/IP Core X sends the SIP Message request to the SIP/IP Core B based on the PoC Address of the PoC User 16. At step 158, The SIP/IP Core B sends the SIP Message request to the PoC Server B based on the feature-tag (e.g., “g.poc.groupad”) in the Accept Contact. At step 160, the PoC Server B performs Access Control and determines that the PoC User 16 at the PoC Client 16 is authorized to send a Group Advertisement to the PoC User 16. The PoC Server B sends the SIP Message request to the SIP/IP Core.

At step 162, The SIP IP/Core B sends the SIP Message to the PoC Client 16 based on information stored during registration. At step 164, the PoC Client 16 sends a SIP 200 “OK” response to the SIP/IP Core B in order to acknowledge that the Group Advertisement was received. The SIP 200 “OK” response is sent along the signaling path to the PoC Server 14. At step 166, the SIP/IP Core B forwards the SIP 200 “OK” response to the SIP/IP Core B. At step 168, the PoC Server B forwards the SIP 200 “OK” response to SIP/IP Core B. At step 170, The SIP/IP Core B forwards the SIP 200 “OK” response to the SIP/IP Core X. At step 172, The SIP/IP Core X forwards the SIP 200 “OK” response to PoC Server X. At step 174, The PoC Server B sends the acknowledgement to the PoC Client 14, which verifies the reception of the Group Advertisement has been acknowledged by the PoC Client 16.

On receipt of the group advertisement (e.g., SIP INVITE request), the potential group members are displayed or otherwise presented to the user of the client B (e.g. electronic equipment 16). Each potential member that receives the request may accept or reject inclusion in the group. The decision to accept or reject may be made by the user of the client B based upon the identity of the members presented to the user prior to joining the group. The rejection/acceptance information can be sent back to the invitee 14 through SIP responses, as discussed above. In one embodiment, the client B may include rejection information. The rejection information may include any additional formation related to rejecting the invitation. For example, rejection information may include a reason for rejecting invitation.

In another embodiment, the client B (e.g., electronic equipment 16) may automatically answer and either accept or reject inclusion into a group based upon one or more predefined contacts contained in the invitation request. For example if user X, does not desire to be included a group session that includes user Y, user X may store a rule in the PoC application 38 to automatically reject group invitations containing user Y. Likewise, if user X would like to join any group containing user Z, user X may store a rule in the PoC application 38 to automatically accept group invitations containing user Z. One of ordinary skill in the art will readily appreciate that a variety of logical functions may be implemented based on the presence and/or absence of particular individuals as group members.

The responses from the client B (e.g., electronic equipment 16) are generally transmitted to client A (e.g., electronic equipment 14) using SIP responses. The PoC application 38 in the client A (e.g., electronic equipment 14) will update the group advertisement membership based on the members accepting and/or rejecting membership to the group. In one embodiment, after the final group membership is determined, the mobile terminal 14 may transmit a notification to the group members for establishment of the group session.

While aspects of the present invention have been described with group advertisements in a PoC communication system, it will be appreciated that aspects of the present invention may be applicable to any call or interaction using a mobile phone when an invitation to join a session is received by a user of the mobile phone. In addition, while aspects of the present invention have been described with respect to PoC communications, it will be appreciated that the present invention is applicable to all push to talk communications.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. It should also be noted that although the specification lists method steps occurring in a particular order, these steps may be executed in any order, or at the same time.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

What is claimed is:

1. A method for establishing a group session, the method comprising:
receiving an invitation from an inviting associated electronic equipment to join a group session, wherein the invitation includes member information relating to a plurality of members receiving the invitation;
presenting at least a portion of the member information to an associated user of an invited electronic equipment;
receiving user input from the associated user of the electronic equipment to accept or reject the invitation to join the group session based at least in part on the portion of the member information presented to the associated user.

2. The method of claim 1, wherein the group session is a push to talk group session.

3. The method of claim 1, wherein the group session is a push to talk over cellular group session.

4. The method of claim 1, wherein the member information is embedded in the invitation.

5. The method of claim 4, wherein the member information is in the form of XML code.

6. The method of claim 4, wherein the member information includes a user friendly designation of at least one of the plurality of members.
The method of claim 4, wherein the member information includes a user friendly designation of at least one of the plurality of members.

7. The method of claim 4, wherein the member information includes a session initiation protocol uniform resource identifier associated with at least one of the plurality of members.

8. The method of claim 1 further including transmitting a rejection of the invitation to the associated first electronic equipment;

9. The method of claim 8 further including rejecting information in the rejection, wherein the rejecting information includes a reason for rejecting the invitation to join the group session.

10. A method for establishing a group session, the method comprising:
transmitting an invitation to a plurality of associated electronic equipment to join a group session from an inviting electronic equipment, wherein the invitation includes member information associated with users of the plurality of associated electronic equipment;
receiving a response from at least a portion of the associated electronic equipment, wherein the response includes either an acceptance or rejection of the invitation; and
forming a group session based on the electronic equipment that accepted the invitation.

11. The method of claim 10, wherein the group session is a push to talk group session.

12. The method of claim 11, wherein the group session is a push to talk over cellular group session.

13. The method of claim 11, wherein the member information is in the form of XML code.

14. The method of claim 13, wherein the member information includes a user friendly designation of at least one user of the plurality of electronic equipment.

15. The method of claim 13, wherein the member information includes a user friendly designation associated with each user of the plurality of electronic equipment.

16. The method of claim 13, wherein the invitation includes a session initiation protocol uniform resource identifier associated with each of the plurality of members.

17. The method of claim 10, wherein at least one response includes a rejection of the invitation to join the group session.

18. The method of claim 17 further including rejection information, wherein the rejection information includes a reason for rejecting the invitation to join the group session.

19. A computer program stored on a machine readable medium, the program being suitable for use in an electronic equipment having an push to talk over cellular application, wherein when the electronic equipment transmits an invitation to a group of electronic equipment, wherein the invitation includes member information associated with invitation, at least one member of the group may view the member information and reject the invitation based at least in part on the portion of the member information viewed by the at least member of the group.

20. The computer program of claim 19, wherein the member information is embedded in the invitation.
